(19) United States
(12) Patent Application Publication
(10) Pub. No.: US 2008/0281701 A1
(43) Pub. Date: Nov. 13, 2008

(54) Combination beach towel chair cover

(76) Inventor: Jeff A. Scheiner, Reston, VA (US)

Correspondence Address: JAMES RAY & ASSOCIATES, 2640 PITCAIRN ROAD, MONROEVILLE, PA, 15146, US

(21) Appl. No.: 11/820,969

(22) Filed: Jun. 21, 2007

Related U.S. Application Data
(60) Provisional application No. 60/928,879, filed on May 11, 2007.

(51) Int. Cl. A47C 31/11; G06Q 30/00; G09F 23/00

(52) U.S. Cl. 705/14; 297/228.11; 297/228.13; 297/229

(57) ABSTRACT

A towel to fit over and be secured to a lounge chair to minimize slipping of the towel when a person in such lounge chair changes position. The towel includes an elongated cloth material of predetermined length to cover the length of such lounge chair and of width to cover the width of such lounge chair. A pouch member, of predetermined length and predetermined depth, is disposed at a first end of the elongated cloth material and engageable over an upper end of a back portion of such lounge chair. A portion of the pouch member is formed from the predetermined material and integrally with the first end thereof for retaining the elongated cloth material in place. There is at least one mechanism secured to and disposed on a second end of the elongated predetermined cloth material for holding the second end on a leg portion of such lounge chair.

### CROSS REFERENCE TO RELATED APPLICATION

This patent application is related to and claims priority from U.S. Provisional Patent Application Ser. No. 60/928,879 filed May 14, 2007.

### FIELD OF THE INVENTION

The present invention relates, in general, to a combination beach towel chair cover and, more particularly, this invention relates to a combination beach towel chair cover that can be secured to a chair in such a way as to be resistant to movement caused by wind or the user's body, and which is long enough to cover the entire seat and leg area of a standard lounge chair and which will not require frequent adjustment by the consumer due to bunching and moving of the towel.

### BACKGROUND OF THE INVENTION

Prior to the conception and development of the present invention, beach towels are generally well known in the prior art, Specifically of interest to the present invention are the following: Pegram U.S. Pat. No. 4,844,540 discloses a combination beach towel and chair cover held in place by one elastic strap at the head of the towel and two elastic straps at the bottom corners of the towel. Walker U.S. Pat. No. 5,441,789 discloses a combination beach towel and chair cover with four attaching straps and tabs of hook and loop type fastening system that can be utilized in such ways as to attach the beach towel to lounge, deck and boat type chairs. Schluter U.S. Pat. No. 4,656,670 discloses a combination beach towel, car seat cover and robe which incorporates a flap in the center of the towel which can be secured in either an open or a closed position through the utilization of hook strips and loop strips. While the opening is secured in the open position the device can be used as a robe, while the opening is secured in the closed position the device may be attached to a car seat or used as a beach towel. The device incorporates a pocket which serves as a means to secure the device to a car seat.

### SUMMARY OF THE INVENTION

The present invention provides a beach towel specifically designed to fit over and be secured to a lounge chair in a manner to minimize slipping of the towel when a person sitting in such lounge chair changes their position. The towel includes an elongated predetermined cloth material having each of a predetermined length which is at least sufficient to cover an entire length of such lounge chair and a predetermined width which is at least sufficient to cover an entire width of such lounge chair. A pouch member, having each of a predetermined length and a predetermined depth, disposed at a first end of such elongated cloth member is engageable over an upper end of a back portion of such lounge chair. At least a portion of the pouch member is formed from the predetermined material and integrally with such first end thereof for retaining the elongated cloth member in place during use. There is at least one means secured to and disposed on a second end of the elongated predetermined cloth material for holding the second end on a leg portion of such lounge chair during use.

### OBJECTS OF THE INVENTION

It is, therefore, one of the primary objects of the present invention to provide a towel specifically designed to fit over and be secured to a lounge chair in a manner to minimize movement of the towel when a person sitting in such lounge chair changes their position.

Another object of the present invention is to provide a combination beach towel chair cover that is large enough to cover a standard size lounge chair resulting in the supreme comfort of the user and protecting the user from the possibly extremely hot portions of the chair.

Still another object of the present invention is to provide a beach towel chair cover combination that is easy to use.

Yet another object of the present invention is to provide a beach towel chair cover combination that can be sold in a variety of colors and/or designs which will be attractive to numerous consumers.

An additional object of the present invention is to provide a beach towel chair cover combination that is inexpensive to manufacture.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of a beach towel according to one embodiment of the present invention.

FIG. 2 is a partial perspective view of the beach towel chair cover combination shown in FIG. 1 ready to be disposed on a lounge chair.

FIG. 3 is a partial perspective view of the beach towel chair cover combination shown in FIGS. 1 and 2 disposed on a lounge chair.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

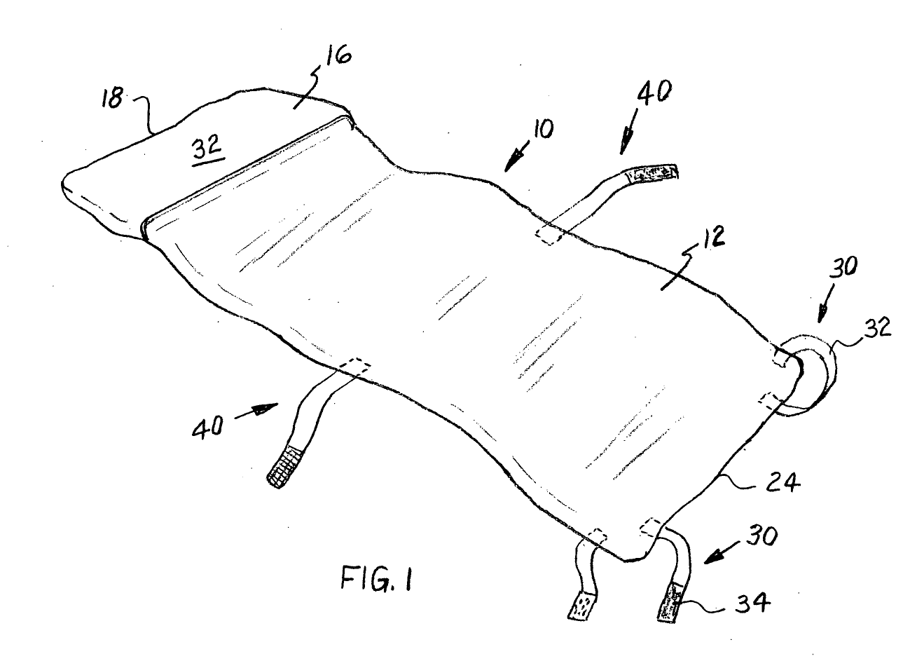

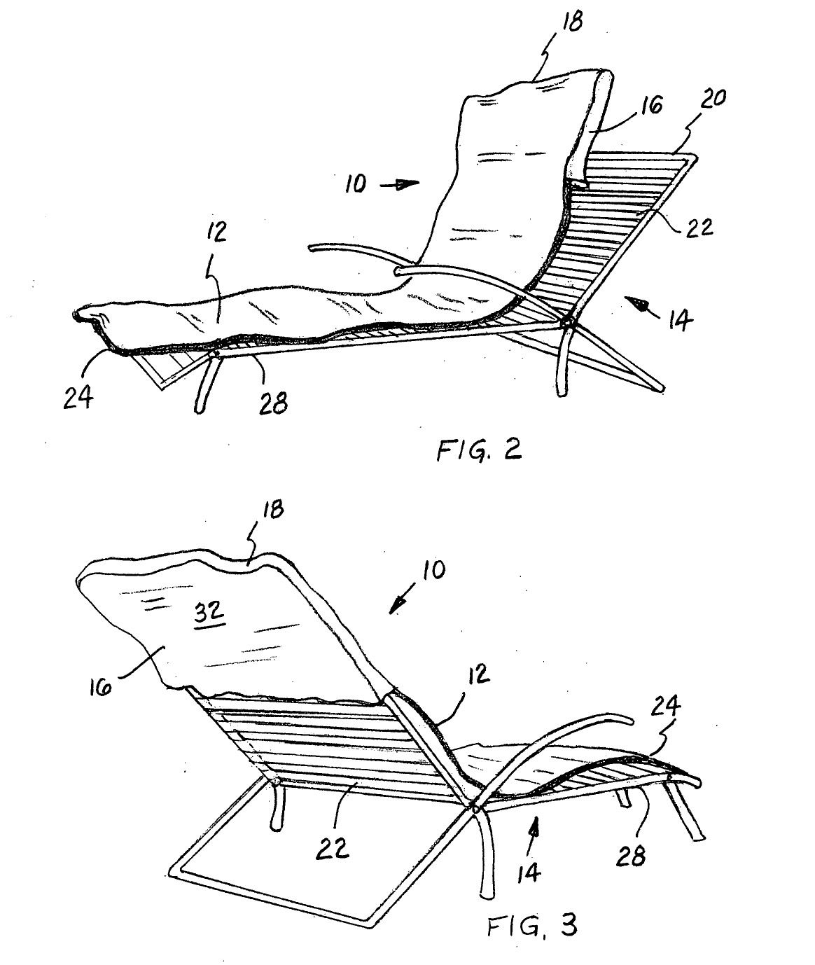

Reference is now made, more particularly, to FIGS. 1-3. According to a first embodiment of the invention, illustrated in FIGS. 1 and 2 there is provided a beach towel chair cover combination, generally designated 10. The beach towel chair cover combination 10 includes a towel 12 specifically designed to fit over and be secured to a lounge chair, generally designated 14, in a manner to minimize slipping of the towel 12 when a person sitting in such lounge chair 14 changes their position.

The towel 12 is formed from an elongated predetermined cloth material having each of a predetermined length which is at least sufficient to cover the entire length of lounge chair 14 and a predetermined width which is at least sufficient to cover an entire width of such lounge chair 14. Preferably, the predetermined cloth material is selected from the group consisting of terrycloth, cotton and a combination thereof. It is most preferred that the cloth material be terrycloth. Additionally, the predetermined length of such elongated cloth material is between about 78.0 inches to about 85.0 inches. Preferably, the predetermined length of such elongated cloth member is between about 80.0 inches and about 82.0 inches. The predetermined width of the elongated cloth material is between about 27.0 inches and 35.00 inches. Preferably, the predetermined width of such elongated cloth material is between about 30.0 inches and 33.00 inches.

A pouch member 16, having each of a predetermined length and a predetermined depth, is disposed at a first end 18 of the elongated cloth material and engageable over an upper end 20 of a back portion 22 of such lounge chair 14. At least a portion of the pouch member 16 is formed from the predetermined cloth material and integrally with the first end 18 thereof for retaining the elongated cloth material in place during use. The final element in a presently preferred embodiment is at least one means, generally designated 30, secured to and disposed on a second end 24 of the elongated predetermined cloth material for holding the second end 24 of the lounge chair 14 on a leg portion 28 of such lounge chair 14 during such use.

In the presently preferred embodiment of the invention, the at least one means, generally designated 40, secured to and disposed on a second end of the elongated predetermined cloth material for holding the second end on a leg portion 28 of such lounge chair 14 during such use is one of an at least one elastic band 32 and a hook and loop type fastener 34.

According to a second embodiment the pouch member 16 of the present invention includes a space 32 on an exposed surface thereof for at least one of advertising on and personalizing the towel 10. In this embodiment of the invention to entice the sale to corporations such space 32 will be used for advertising. Such advertising is preferably sewn one of in and on the predetermined cloth material.

According to yet another embodiment of the invention the pouch 16 includes a waterproof material (not shown) disposed on an outer surface thereof and such advertising is painted on such waterproof material.

According to presently preferred embodiment of the invention the predetermined length of such pouch member 16 is substantially identical to the predetermined width of the elongated cloth material and the predetermined depth of the pouch member 16 is between about 12.0 inches and about 18.0 inches, preferably, between about 15.0 inches and about 16.5 inches.

According to the presently preferred embodiment of the invention, the towel 10 further includes a securing means, generally designated 40, preferably, a hook and loop type securing means connected to and disposed substantially midway between the first end 18 and the second end 24 of the elongated predetermined cloth material for retaining a middle portion of the cloth material in place during use.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A towel specifically designed to fit over and be secured to a lounge chair in a manner to minimize slipping of said towel when a person sitting in such lounge chair changes their position, said towel comprising:
(a) an elongated predetermined cloth material having each of a predetermined length which is at least sufficient to cover an entire length of such lounge chair and a predetermined width which is at least sufficient to cover an entire width of such lounge chair;
(b) a pouch member, having each of a predetermined length and a predetermined depth, disposed at a first end of said elongated cloth material and engageable over an upper end of a back portion of such lounge chair, at least a portion of said pouch member formed from said predetermined material and integrally with said first end thereof for retaining said elongated cloth material in place during use.

2. A towel according to claim 1, wherein said pouch member includes a space on an exposed surface thereof for at least one of advertising on and personalizing said towel.

3. A towel, according to claim 1, wherein said space on said exposed outer surface of said pouch member includes advertising.

4. A towel, according to claim 3, wherein said advertising is sewn one of in and on said predetermined cloth material.

5. A towel, according to claim 3 wherein said pouch includes a waterproof material disposed on an outer surface thereof and said advertising is painted on said waterproof material.

6. A towel, according to claim 1, wherein said predetermined cloth material is selected from the group consisting of terrycloth, cotton and a combination thereof.

7. A towel, according to claim 6, wherein said predetermined cloth material is terrycloth.

8. A towel, according to claim 1, wherein said predetermined length of said elongated cloth material is between about 78.0 inches to about 85.0 inches.

9. A towel, according to claim 1, wherein said predetermined length of said elongated cloth material is between about 80.0 inches and about 82.0 inches.

10. A towel, according to claim 1, wherein said predetermined width of said elongated cloth material is between about 27.0 inches and 35.00 inches.

11. A towel, according to claim 10, wherein said predetermined width of said elongated cloth material is between about 30.0 inches and 33.00 inches.

12. A towel, according to claim 1, wherein said towel further includes at least one means secured to and disposed on a second end of said elongated predetermined cloth material for holding said second end on a leg portion of such lounge chair during such use is one of an at least one elastic band and a hook and loop type fastener.

13. A towel, according to claim 12, wherein said at least one means secured to and disposed on a second end of said elongated predetermined cloth material for holding said second end on a leg portion of such lounge chair during such use is at least one elastic band.

14. A towel, according to claim 1, wherein said predetermined length of said pouch member is substantially identical to said predetermined width of said elongated cloth material.

15. A towel, according to claim 14, wherein said predetermined depth of said pouch member is between about 12.0 inches and about 18.0 inches.

16. A towel, according to claim 15, wherein said predetermined depth of said pouch member is between about 15.0 inches and about 16.5 inches.

17. A towel, according to claim 1, wherein said towel further includes a securing means connected to and disposed substantially midway between said first end and said second end of said elongated predetermined cloth material for retaining a middle portion of said cloth material in place during use.

18. A towel, according to claim 17, wherein said means for retaining said middle portion of said cloth material in place includes a hook and loop type securing means disposed of mating ends of a pair of strap like members.
